(19) United States
(12) Patent Application Publication
(10) Pub. No.: US 2019/0072277 A1
(43) Pub. Date: Mar. 7, 2019

(54) TRAILING EDGE BOX AND FUEL SPRAYBAR WITH INTERNAL PASSAGES

(71) Applicant: United Technologies Corporation, Farmington, CT (US)

(72) Inventors: Jose E. Ruberte Sanchez, Jupiter, FL (US); Jeffery A Lovett, Tolland, CT (US)

(21) Appl. No.: 15/695,183

(22) Filed: Sep. 5, 2017

(51) Int. Cl. F23R 3/20; F02K 3/10; F23R 3/28

(52) U.S. Cl. CPC F23R 3/20; F02K 3/10; F05D 2260/30; F05D 2220/32; F05D 2230/60; F23R 3/283

(57) ABSTRACT

A trailing edge box for an augmentor vane includes an exterior-facing slot extending longitudinally along the trailing edge box. A monolithic spraybar provides fuel to a working environment of the augmentor vane. The monolithic spraybar includes a spray arm that is slidably inserted into the slot. A fuel aperture is integral with and extends into the spray arm. The fuel aperture receives fuel provided through a supply passage in the spray arm and provides the fuel to the working environment. The spray arm is disposed in the slot such that the fuel aperture is directly exposed to the working environment.

### STATEMENT OF GOVERNMENT INTEREST

This invention was made with government support under Contract No. FA8650-09-D-2923 awarded by the United States Air Force. The government has certain rights in the invention.

### BACKGROUND

This disclosure relates generally to augmentors. More particularly, this disclosure relates to a trailing edge box and fuel spraybar.

Augmentors, or afterburners, are located at an axially aft end of a gas turbine engine, between the turbine sections and the exhaust case. Augmentors supply additional fuel to the exhaust gasses exiting the turbine section of a gas turbine engine and ignite the additional fuel to obtain a second combustion. The second combustion provides additional thrust to the gas turbine engine. Augmentor vanes extend between and connect a radially outer and radially inner case. A trailing edge box is attached to the trailing edge of the augmentor vane, and the trailing edge box houses the fuel spraybar that introduces fuel to the augmentor.

To provide fuel to the augmentor, the trailing edge box includes a multitude of fuel spray windows extending through the trailing edge box. The fuel spraybar extends through the trailing edge box and provides fuel to the fuel spray windows through orifices. The orifices are aligned with the fuel spray windows and the position of the orifice relative to the fuel supply window is maintained by blocks, clips, springs, and other components. With the fuel spraybar disposed in the trailing edge box, the window and the orifice can become misaligned due to vibration and/or relative movement, leading to an eclipsing, or a partial blockage of the fuel flow out of the window. In addition, the fuel spraybar typically includes multiple tubes that are brazed and/or welded together, and the orifice structure and associated components are also typically assembled through a mechanical process, such as brazing or welding.

### SUMMARY

According to one aspect of the disclosure, a fuel spraybar includes a first spray arm extending from a base and including a first longitudinal axis and a second spray arm extending from the base and including a second longitudinal axis. The first spray arm includes at least one first internal passage extending through the first spray arm from the base and at least one fuel aperture extending into the first spray arm and fluidly connected to the at least one first passage. The second spray arm includes the least one first internal passage extending through the second spray arm from the base and at least one fuel aperture extending into the second spray arm and fluidly connected to the at least one first internal passage.

According to another aspect, a fuel supply assembly includes a trailing edge box for an augmentor vane and a fuel spraybar. The trailing edge box includes a first sidewall extending between a forward end of the trailing edge box and a rear end of the trailing edge box, the first sidewall including a first slot open to a trailing edge box exterior, a second sidewall spaced from the first sidewall and extending between the forward end and the rear end, the second sidewall including a second slot open to the trailing edge box exterior, and a compartment disposed between the first sidewall and the second sidewall, the compartment configured to provide cooling air to the rear end of the trailing edge box. The fuel spraybar includes a first spray arm extending from a base, the first spray arm configured to supply fuel to a working environment through a plurality of first fuel apertures, the plurality of first fuel apertures integral with and extending into the first spray arm, and a second spray arm extending from the base, the second spray arm configured to supply fuel to the working environment through a plurality of second fuel apertures, the plurality of second fuel apertures integral with and extending into the second spray arm. The first spray arm is disposed in the first slot and the second spray arm is disposed in the second slot.

According to yet another aspect, a method of assembling an augmentor vane includes attaching a trailing edge box to an augmentor vane; and sliding a spray arm of the monolithic spraybar into a slot extending longitudinally along the trailing edge box, wherein the slot includes a retaining portion extending into a slot opening and configured to circumferentially retain the spray arm within the slot.

### BRIEF DESCRIPTION OF THE DRAWINGS

FIG. 1 is a schematic view of a gas turbine engine.

FIG. 2 is a schematic view of an augmentor vane in a working environment with a spraybar installed.

FIG. 3A is a side elevation view of a trailing edge box.

FIG. 3B is a cross-sectional view taken along line 3-3 in FIG. 3A.

FIG. 4 is a cross-sectional view taken along line 4-4 in FIG. 3A.

FIG. 5A is an front elevation view of a fuel spray bar.

FIG. 5B is a side elevation view of a fuel spray bar.

FIG. 5C is a perspective view of detail Z in FIG. 5B.

FIG. 6A is a cross-sectional view taken along line A-A in FIG. 5B.

FIG. 6B is a cross-sectional view taken along line B-B in FIG. 5B.

FIG. 7A is a top view of a spraybar and a support.

FIG. 7B is a cross-sectional view of a connection of a fuel spray bar and a support.

FIG. 8 is a flow chart of a method of assembling an augmentor vane.

### DETAILED DESCRIPTION

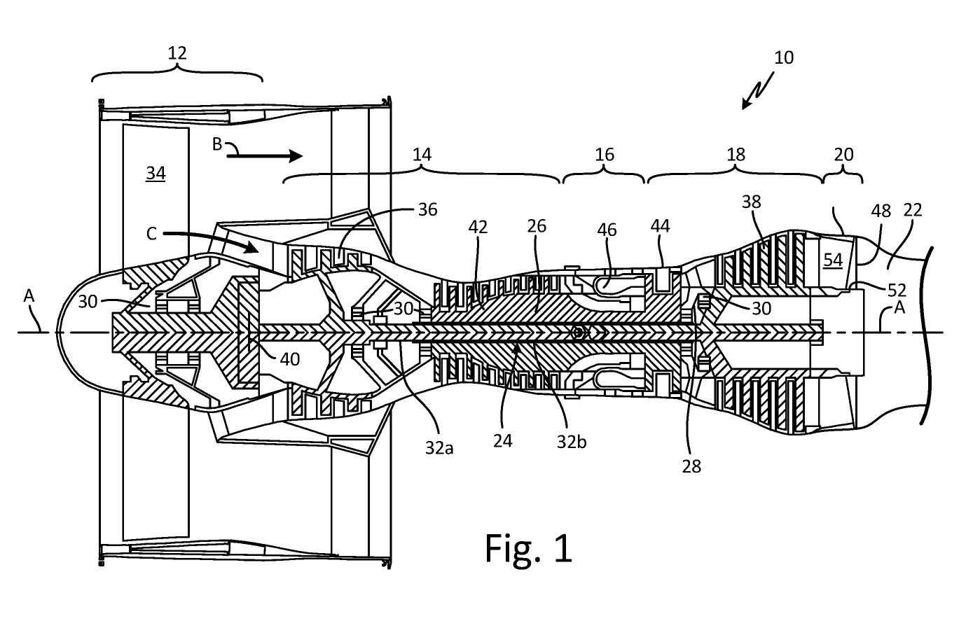

FIG. 1 is a schematic cross-sectional view of gas turbine engine 10. Gas turbine engine 10 includes fan section 12, compressor section 14, combustor section 16, turbine section 18, and augmentor section 20. Fan section 12 drives air along bypass flowpath B while compressor section 14 draws air in along core flowpath C where air is compressed and communicated to combustor section 16. In combustor section 16, air is mixed with fuel and ignited to generate a high pressure exhaust gas stream that expands through turbine section 18 where energy is extracted and utilized to drive fan section 12 and compressor section 14. Exhaust from turbine section 18 flows through augmentor section 20, or afterburner, where the exhaust gasses are mixed with fuel and ignited to provide additional thrust to gas turbine engine 10. The exhaust gasses exit gas turbine engine 10 through exhaust nozzle 22.

Gas turbine engine 10 generally includes low speed spool 24 and high speed spool 26 mounted for rotation about center axis A of gas turbine engine 10 relative to engine static structure 28 via several bearing systems 30. It should be understood that various bearing systems 30 at various locations may alternatively or additionally be provided.

Low speed spool 24 generally includes inner shaft 32a that connects fan 34 and low pressure (or first) compressor section 36 to low pressure (or first) turbine section 38. Inner shaft 32 drives fan 34 through a speed change device, such as geared architecture 40, to drive fan 34 at a lower speed than low speed spool 24. High-speed spool 22 includes outer shaft 28b that interconnects high pressure (or second) compressor section 42 and high pressure (or second) turbine section 44. Inner shaft 32a and outer shaft 32b are concentric and rotate via bearing systems 30 about center axis A.

Combustor 46 is arranged between high pressure compressor 42 and high pressure turbine 44. In one example, high pressure turbine 44 includes at least two stages to provide double stage high pressure turbine 44. In another example, high pressure turbine 44 includes only a single stage. As used herein, a “high pressure” compressor or turbine experiences a higher pressure than a corresponding “low pressure” compressor or turbine.

Turbine exhaust case 48 of engine static structure 28 is located between exhaust nozzle 22 and low pressure turbine 38. Turbine exhaust case 48 includes outer ring 50 and inner ring 52, with augmentor vanes 54 extending between and connecting outer ring 50 and inner ring 52.

The gas flow in core flowpath C is compressed first by low pressure compressor 36 and then by high pressure compressor 42, is mixed with fuel and ignited in combustor 46 to produce high speed exhaust gases, and the high speed exhaust gasses are then expanded through high pressure turbine 44 and low pressure turbine 38. The exhaust gasses flow through turbine exhaust case 48 and augmentor vanes 54 direct and stabilize the flow of exhaust gasses discharged from combustor 46 after the exhaust gasses have passed through high pressure turbine 44 and low pressure turbine 38. Augmentor vanes 54 also introduce fuel to the exhaust gasses through turbine exhaust case 48. The fuel introduced to core flowpath C through augmentor vanes 54 is ignited by an ignition source. In some examples, turbine exhaust case 48 includes a plurality of augmentor vanes 54 and a plurality of ignition sources. In one example, turbine exhaust case 48 includes an equal number of augmentor vanes 54 and ignition sources. The combusted exhaust gasses flow through exhaust nozzle 22 and provide additional thrust to gas turbine engine 10.

Although the disclosed non-limiting embodiment depicts a turbofan gas turbine engine, it should be understood that the concepts described herein are not limited to use with turbofans as the teachings may be applied to other types of turbine engines; for example, an industrial gas turbine; a reverse-flow gas turbine engine; and a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section. It is further understood that the concepts described herein can be applied to test rigs and other environments similar to those experienced within a gas turbine engine.

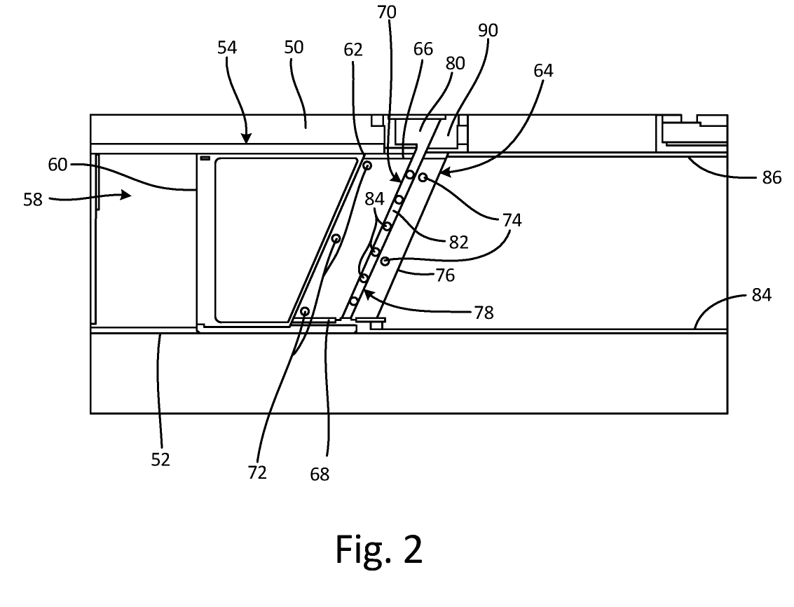

FIG. 2 is a schematic view showing augmentor vane 54 in a working environment with spraybar 78 installed. Augmentor vane 54 is disposed within flowpath 58 between outer case 50 and inner case 52 and includes leading edge 60 and trailing edge 62. Trailing edge box 64 includes outer end 66, inner end 68, slot 70, vane fastener openings 72, and flame holder fastener openings 74. Flame holder 76 is disposed at an aft end of trailing edge box 64. Spraybar 78 includes base 80 and spray arm 82. Spray arm 82 includes fuel apertures 84.

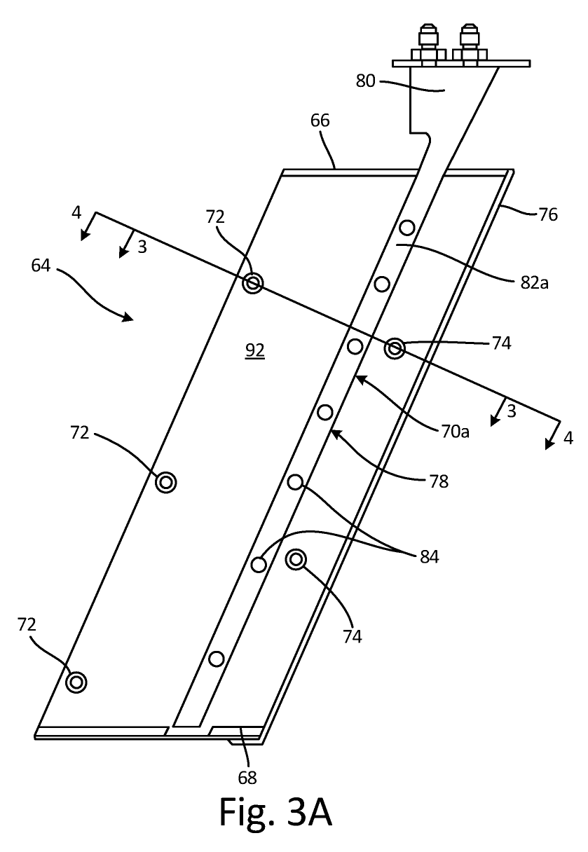

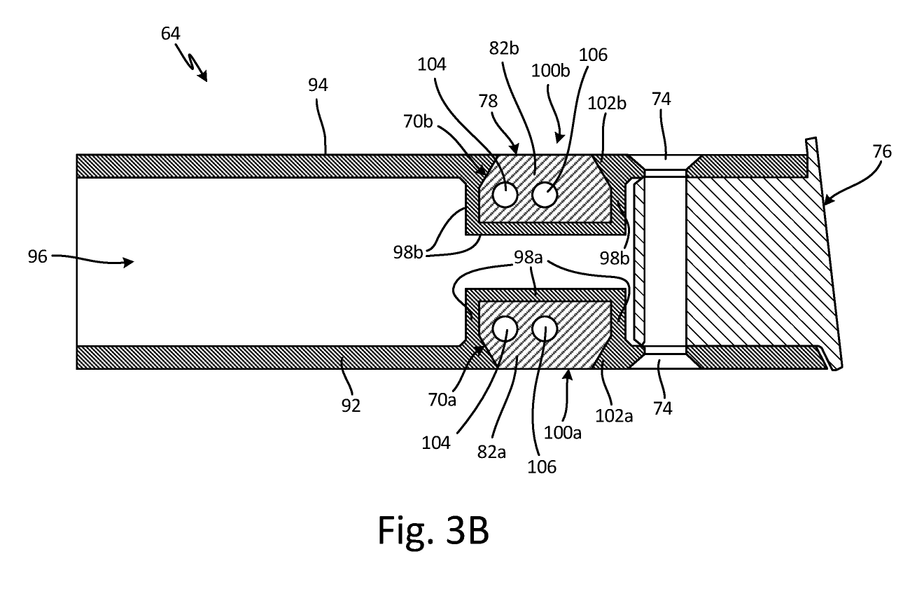

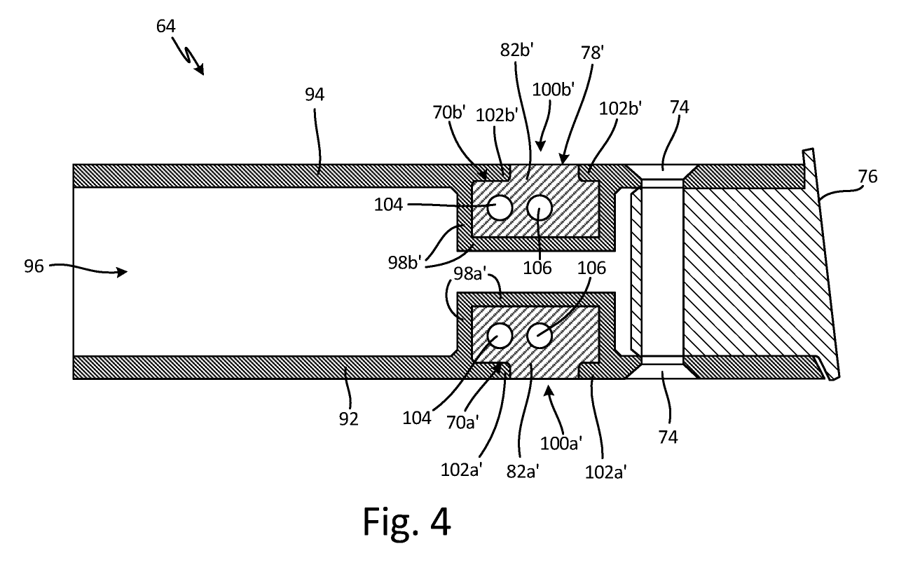

Trailing edge box 64 is attached to trailing edge 62 of augmentor vane 54 by fasteners extending into augmentor vane 54 through vane fastener openings 72 in trailing edge box 64. Flame holder 76 (best seen in FIGS. 3B and 4) is secured to an aft end of trailing edge box 64 by fasteners extending through flame holder fastener openings 74. Slots 70 extend longitudinally along trailing edge box 64 and are open to flowpath 58. Flowpath 58 extends radially between inner diameter 84 and outer diameter 86.

Spraybar 78 is configured to supply fuel to flowpath 58. Flange support 90 is supported on outer case 50 and supports spraybar 78 relative to trailing edge box 64. Base 80 is disposed in and supported by flange support 90. Spray arm 82 is integral with and extends from base 80. Fuel apertures 84 extend into spray arm 82 and are exposed directly to flowpath 58. Spraybar 78 includes a supply passage extending through base 80 and spray arms 82. Fuel apertures 84 are fluidly connected to the supply passage and receive fuel from the supply passage. Spraybar 78 can be oriented such that spraybar 78 receives fuel from radially outward of outer case 50 or radially inward of inner case 52. While spraybar 78 is described as supported by flange support 90 and outer case 50, it is understood that spraybar 78 can be supported by outer case 50 or inner case 52. For example, while spraybar 78 is shown with spray arms 82 extending towards inner case 52 from outer case 50, it is understood that spraybar 78 can also be disposed such that base 80 is supported in inner case 52 and spray arms 82 extend towards outer case 50 from inner case 52.

Spray arm 82 is disposed in slot 70 and extends longitudinally along trailing edge box 64. Spraybar 78 is installed on or removed from trailing edge box 64 by sliding spray arm 82 into slot 70. Slot 70 can have a cross-sectional shape configured to retain spray arm 82 within slot 70, and it is understood, that spray arm 82 can include a cross-sectional shape configured to mate with the cross-sectional shape of the slot 70. As such, no fasteners are required to retain spray arm 82 within slot 70. Moreover, spray arm 82 and base 80 can be integrally formed and fuel apertures 84 can be integrally formed in spray arm 82 such that spraybar 78 is monolithic. Spraybar 78 is monolithic such that fuel apertures 84 are correctly oriented and aligned without blocks, springs, clips, or other additional components that can cause wear. With spray arm 82 being slidable within slot 70, and spraybar 78 being monolithic, spraybar 78 is supported on trailing edge box 64 and provides fuel out of fuel apertures 84 without additional components, thereby reducing the number of parts and eliminating wear concerns.

During operation, augmentor vane 54 directs a flow of gasses through flowpath 58. A fuel source (not shown) is connected to base 80 by one or more fuel fittings, and the fuel source provides fuel to spraybar 78 through the fuel fittings. The fuel enters the supply passage in base 80 and flows through the supply passage to fuel apertures 84. Fuel apertures 84 spray the fuel into flowpath 58, where the fuel is ignited.

Augmentor vane 54 provides significant advantages. Spraybar 78 can be monolithic and can be produced through an additive manufacturing process, such as direct metal laser sintering, and spraybar 78 can be installed on trailing edge box 64 by sliding spray arm 82 into slot 70, simplifying installation and removal of spraybar 78, thereby reducing maintenance time requirements. Moreover, no additional fasteners or other components are required to secure spray arm 82 within slot 70, thereby simplifying trailing edge box 64 and spraybar 78. In addition, the internal passages and fuel apertures 84 can be integrally formed in spraybar 78 and fuel apertures 84 are directly exposed to flowpath 58. Integrally forming fuel apertures 84 eliminates relative movement of components that can partially obstruct fuel apertures 84 and eliminates wear and leakage concerns. Ensuring that fuel apertures 84 remain unblocked increases performance and efficiency.

FIG. 3A is a side elevation view of trailing edge box 64 and spraybar 78. FIG. 3B is a cross-sectional view taken along line 3-3 in FIG. 3A. FIGS. 3A and 3B will be discussed together. Trailing edge box 64 includes outer end 66, inner end 68, slots 70a and 70b, vane fastener openings 72, flame holder fastener openings 74, first wall 92, second wall 94, and compartment 96. Slot 70a includes slot walls 98a, slot opening 100a, and retaining portion 102a. Slot 70b includes slot walls 98b, slot opening 100b and retaining portion 102b. Flame holder 76 is disposed at an aft end of trailing edge box 64. Spraybar 78 includes base 80, spray arms 82a and 82b, first supply passage 104, and second supply passage 106. Spray arms 82a and 82b include fuel apertures 84.

Trailing edge box 64 is configured to attach to a trailing edge of a vane, such as augmentor vane 54 (best seen in FIG. 2). First wall 92 is attached to a first side of the vane by fasteners extending through vane fastener openings 72 in first wall 92, and second wall 94 is similarly attached to a second side of the vane by fasteners extending through vane fastener openings 72 in second wall 94. Flame holder 76 is disposed at an aft end of trailing edge box 64 between first wall 92 and second wall 94. Flame holder 76 is secured to trailing edge box 64 by fasteners extending through flame holder fastener openings 74 in first wall 92 and second wall 94. Compartment 96 provides a flowpath for cooling air to flow to flame holder 76 through trailing edge box 64. The cooling air flows into compartment 96 from the vane on which trailing edge box 64 is mounted. The cooling air flows through compartment 96, between slot 70a and slot 70b, and to flame holder 76.

First wall 92 is spaced from second wall 94, and first wall 92 and second wall 94 define compartment 96. Slot walls 98a are attached to first wall 92 and define slot 70a. Slot 70a extends longitudinally along first wall 92, and slot 70a is configured to receive spray arm 82a. Retaining portion 102a extends from first wall 92 into slot opening 100a. As such, slot opening 100a is narrower than slot 70a such that slot opening 100a can retain an object, such as spray arm 82a, within slot 70a. Slot walls 98b are attached to second wall 94 and define slot 70b. Slot 70b extends longitudinally along second wall 94, and slot 70b is configured to receive spray arm 82b. Retaining portion 102b extends from second wall 94 into slot opening 100b. Slot opening 100b is thus narrower than slot 70b such that slot opening 100b can retain an object, such as spray arm 82b, within slot 70b. In FIG. 3B, retaining portion 102a is a tapered wall extending into slot opening 100a, and retaining portion 102b is a tapered wall extending into slot opening 100b.

Slot walls 98a and 98b can be attached to first wall 92 and second wall 94, respectively, in any desired manner to form slot 70a and slot 70b. In some examples, slot walls 98a and 98b are integrally formed with first wall 92 and second wall 94, respectively. In one example, trailing edge box 64 can be formed through an additive manufacturing process, such as direct metal laser sintering (DMLS), among others, such that slot walls 98a and 98b are unitary with first wall 92 and second wall 94, respectively. In another example, first wall 92 can be a unitary piece of sheet metal bent to form slot 70a, and second wall 94 can be a piece of sheet metal bent to form slot 70b. It is understood, however, that trailing edge box 64 can be manufactured using any desired manufacturing process, such as casting, forging, or any other suitable manufacturing process. In some examples, slot walls 98a can be manufactured separate from first wall 92 and later connected to first wall 92 to form slot 70a. Slot walls 98a can be attached to first wall 92a by welding, brazing, or any other mechanical fastening process suitable for withstanding the operating conditions in a working environment of trailing edge box 64.

With slot walls 98a attached to first wall 92 and slot walls 98b attached to second wall 94, compartment 96 is isolated from slots 70a and 70b. Isolating compartment 96 from slots 70a and 70b prevents any cooling air from leaking out of compartment 96 through slots 70a and 70b. Preventing cooling air from leaking out of compartment 96 reduces the volume of cooling air required, thereby increasing efficiency.

Spray arms 82a and 82b are integral with and extend from base 80. In some examples, base 80 is supported by outer case 50 or inner case 52. It is understood, however, that spraybar 78 can be supported in any desired manner. For example, base 80 can be directly connected to trailing edge box 64. In some examples, base 80 is connected, such as via a fastener, such as a bolt, to a radially outer portion of trailing edge box 64 and spray arms 82a and 82b extend radially inward from base 80. In some other examples, base 80 is connected, such as via a fastener, to a radially inner portion of trailing edge box 64 and spray arms 82a and 82b extend radially outward from base 80.

First supply passage 104 extends from base 80 through both spray arm 82a and spray arm 82b. Second supply passage 106 extends from base 80 through both spray arm 82a and spray arm 82b. Fuel apertures 84 extend into spray arms 82a and 82b and are fluidly connected to one of first supply passage 104 and second supply passage 106. Fuel apertures 84 are configured to receive fuel from one of first supply passage 104 and second supply passage 106 and to provide the fuel to flowpath 58 (shown in FIG. 2). While spraybar 78 is described as including first supply passage 104 and second supply passage 106, it is understood that spraybar can include as many or as few supply passages as desired.

Spraybar 78 can be monolithic and can be additively manufactured, such as by direct metal laser sintering, for example, with spray arms 82 integral with and extending from base 80. Spray arm 82a extends from base 80 and is disposed in slot 70a, and spray arm 82b extends from base 80 and is disposed in slot 70b. Spray arm 82a can include any desired cross-sectional profile for mating with slot 70a. Spray arm 82a includes a tapered portion configured to mate with retaining portion 102a, and spray arm 82b includes a tapered portion configured to mate with retaining portion 102b. Spray arms 82a and 82b ride in slots 70a and 70b, respectively, and are retained in slots 70a and 70b by retaining portions 102a and 102b, respectively. Retaining portions 102a and 102b circumferentially retain spray arms 82a and 82b, respectively, but spray arms 82a and 82b are able to float within slots 70a and 70b. Spray arms 82a and 82b floating in slots 70a and 70b allows for relative movement between trailing edge box 64 and spraybar 78 during operation, such as movement due to thermal growth or vibrations, without creating stresses between trailing edge box 64 and spraybar 78. Moreover, with fuel apertures 84 integrally formed in spray arm 82a and spray arm 82b, any relative movement does not inhibit fuel flow through fuel apertures 84.

Spraybar 78 can be installed on or removed from trailing edge box 64 by sliding spray arms 82a and 82b into slots 70a and 70b, respectively. Spray arm 82a is disposed in slot 70a such that fuel apertures 84 extending into spray arm 82a are aligned with slot opening 100a. Similarly, spray arm 82b is disposed in slot 70b such that fuel apertures extending into spray arm 82b are aligned with slot opening 100b. Aligning fuel apertures 84 with slot openings 100a and 100b exposes fuel apertures 84 directly to the working environment that trailing edge box 64 is disposed in. Fuel apertures 84 and the internal passages can be integrally formed in spraybar 78. With fuel apertures 84 integrally formed on spray arms 82 and with spray arms 82 disposed in slots 70, fuel apertures 84 are exposed directly to flowpath 58. Directly exposing the integrally-formed fuel apertures 84 to flowpath 58 ensures that fuel apertures 84 provide a desired flow of fuel to flowpath 58. Unlike fuel apertures that are formed through the trailing edge box, which are subject to eclipsing, which occurs when a fuel aperture becomes at least partially obstructed by another component due to vibration or relative movement, fuel apertures 84 are integral with spray arms 82 and as such are not subject to eclipsing, which enhances augmentor performance.

Trailing edge box 64 and spraybar 78 provide significant advantages. Spraybar 78 can be slidably installed on or removed from trailing edge box 64, providing for simple installation and removal, thereby reducing maintenance costs and time. Slot walls 98a and 98b are attached to first wall 92 and second wall 94, eliminating any leakage between compartment 96 and slots 70a and 70b and thereby improving efficiency. Moreover, retaining portions 102a and 102b retain spray arms 82a and 82b in slots 70a and 70b, respectively. As such, spray arms 82a and 82b ride in slots 70a and 70b without requiring any additional fasteners, providing a simplified arrangement and reducing stresses that can be created due to a fixed connection. Moreover, having spray arms 82a and 82b ride in slots 70a and 70b allows for relative movement between trailing edge box 64 and spraybar 78 without creating or transferring additional stresses between trailing edge box 64 and spraybar 78.

FIG. 4 is another cross-sectional view taken along line 4-4 in FIG. 3A. Slots 70a′ and 70b′, flame holder fastener openings 74, first wall 92, second wall 94, and compartment 96 of trailing edge box 64 are shown. Slot 70a′ includes slot walls 98a′, slot opening 100a′, and retaining portion 102a′. Slot 70b′ includes slot walls 98b′, slot opening 100b′, and retaining portion 102b′. Flame holder 76 is disposed at an aft end of trailing edge box 64. Spraybar 78′ includes base 80, spray arms 82a′ and 82b′, first supply passage 104, and second supply passage 106.

Trailing edge box 64 is configured to attach to a trailing edge of a vane, such as augmentor vane 54 (best seen in FIG. 2). First wall 92 is attached to a first side of the vane by fasteners extending through vane fastener openings 72 in first wall 92, and second wall 94 is similarly attached to a second side of the vane by fasteners extending through vane fastener openings 72 in second wall 94. Flame holder 76 is secured at an aft end of trailing edge box 64 between first wall 92 and second wall 94 by fasteners extending through flame holder fastener openings 74 in first wall 92 and second wall 94. Compartment 96 provides a flowpath for cooling air to flow to flame holder 76 through trailing edge box 64. The cooling air flows into compartment 96 from the vane on which trailing edge box 64 is mounted. The cooling air flows through compartment 96, between slot 70a′ and slot 70b′, and to flame holder 76.

First wall 92 is spaced from second wall 94, and first wall 92 and second wall 94 define compartment 96. Slot walls 98a′ are attached to first wall 92 and define slot 70a′. Slot 70a′ extends longitudinally along first wall 92, and slot 70a′ is configured to receive spray arm 82a′. Retaining portion 102a′ extends from first wall 92 into slot opening 100a. Retaining portion 102a′ is a flange extending from first wall 92 into slot opening 100a′, such that slot opening 100a′ is narrower than slot 70a′ and an object, such as spray arm 82a′, cannot displace circumferentially out of slot 70a′ through slot opening 100a′. Slot walls 98b′ are attached to second wall 94 and define slot 70b′. Slot 70b′ extends longitudinally along second wall 94, and slot 70b′ is configured to receive spray arm 82b′. Retaining portion 102b′ extends from second wall 94 into slot opening 100b′. Retaining portion 102b′ is a flange extending from second wall 94 into slot opening 100b′, such that slot opening 100b′ is narrower than slot 70b′ and an object, such as spray arm 82b′, cannot displace circumferentially from slot 70b′ through slot opening 100b′.

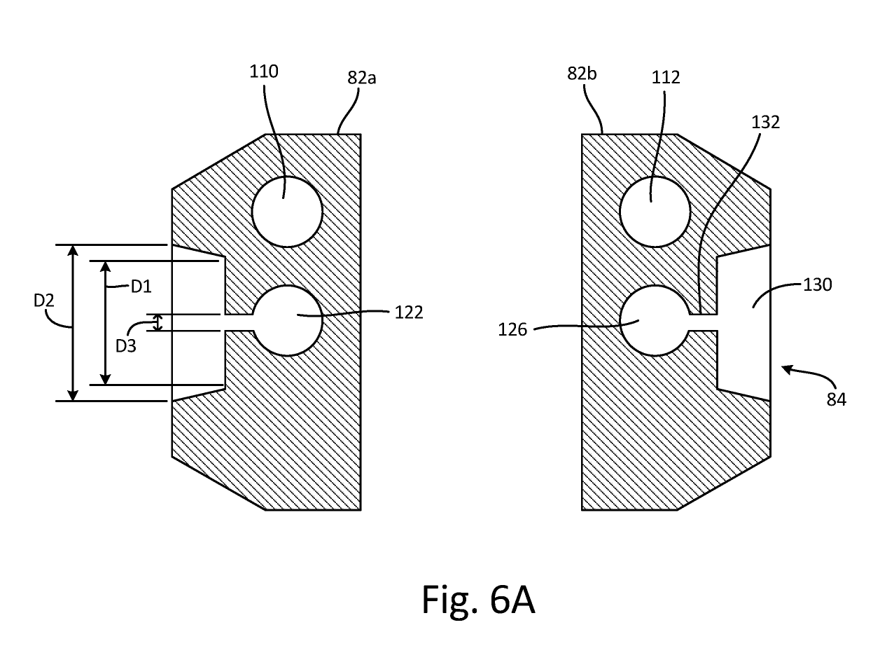

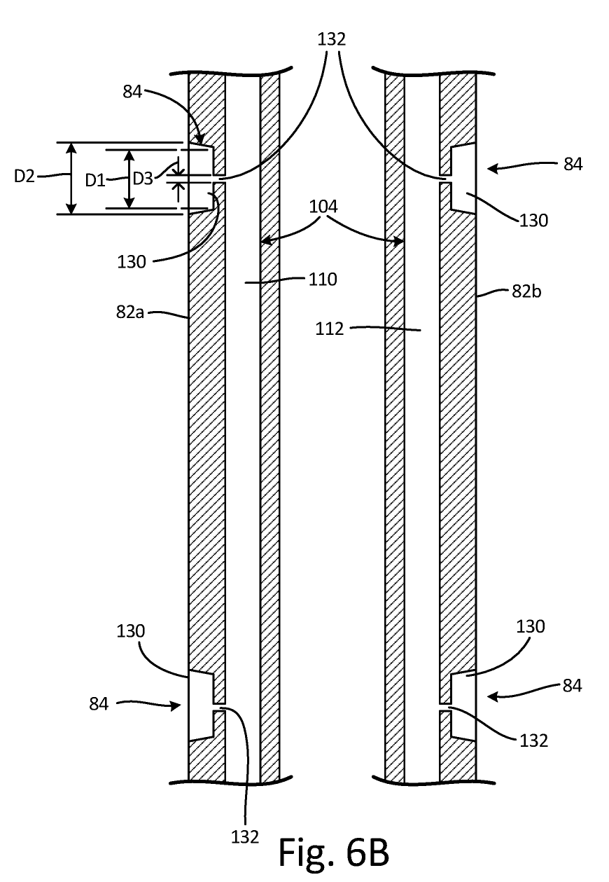

Both slot 70a′ and slot 70b′ have a rectangular cross-section. Spray arm 82a′ similarly has a rectangular cross-section configured to mate with the cross-section of slot 70a′. Spray arm 82b′ similarly has a rectangular cross-section configured to mate with the cross-section of slot 70b′. While slots 70a′ and 70b′ and spray arms 82a′ and 82b′ are described as having rectangular cross-sections, it is understood that slots 70a′ and 70b′ and spray arms 82a′ and 82b′ can be of any desired configuration for providing fuel directly to flowpath 58 (shown in FIG. 2). For example, slots 70a′ and 70b′ can be circular, triangular, quadrangular, or of any other desired polygonal shape. Spray arms 82a′ and 82b′ can be of any desired shape capable of mating with and sliding within slots 70a′ and 70b′. Regardless of a cross-sectional shape of slots 70′ and spray arms 82′, fuel apertures 84 (best seen in FIGS. 6A and 6B) are aligned with slot openings 100′ such that fuel apertures 84 are exposed directly to a working environment.

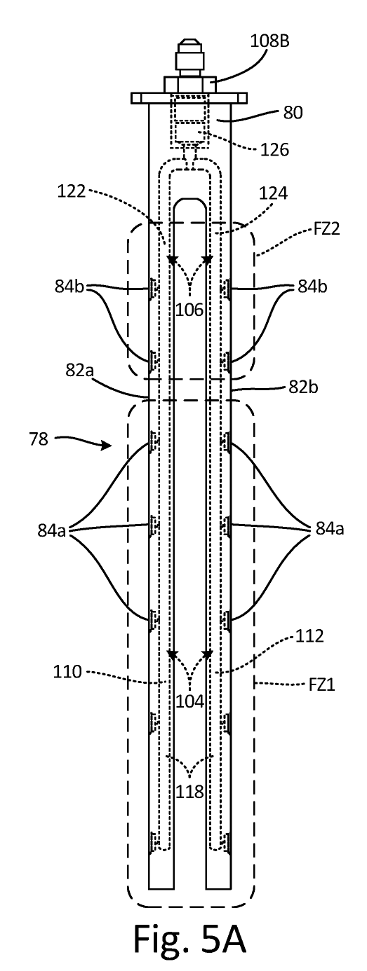

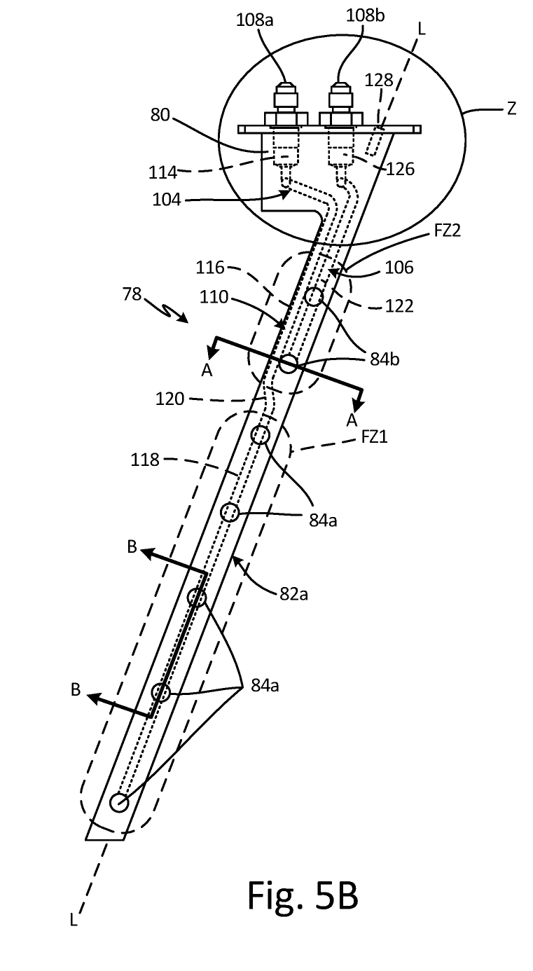

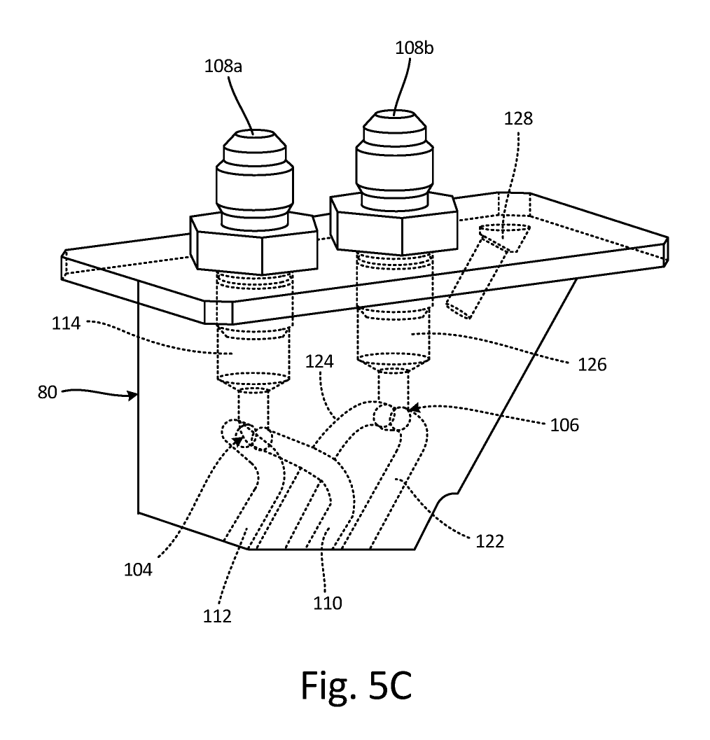

FIG. 5A is an elevation view of spraybar 78. FIG. 5B is a side elevation view of spraybar 78. FIG. 5C is a perspective view of detail Z in FIG. 5B. FIGS. 5A-5C will be discussed together. Spraybar 78 includes base 80, spray arms 82a and 82b, first supply passage 104, second supply passage 106, fuel apertures 84a and 84b (collectively “fuel apertures 84”), and fuel fittings 108a and 108b. First supply passage 104 includes first branch 110, second branch 112, and supply port 114. First branch 110 and second branch 112 of first supply passage 104 each include first portion 116, second portion 118, and offset passage 120. Second supply passage 106 includes first branch 122, second branch 124, and supply port 126. Base 80 includes tapped hole 128.

Spray arm 82a and spray arm 82b are integral with and extend from base 80. Tapped hole 128 extends into base 80. Tapped hole 128 is configured to receive an object to facilitate installation and removal of spraybar 78 in a working environment, for example on a trailing edge box, such as trailing edge box 64 (shown in FIG. 2). In some examples, tapped hole 128 is a threaded hole configured to receive a threaded object, such as a bolt, which can be utilized to install or remove spraybar 78.

Fuel apertures 84a and 84b are integral with and extend into both spray arm 82a and spray arm 82b. Fuel apertures 84a are disposed in first fuel zone FZ1, and fuel apertures 84b are disposed in second fuel zone FZ2. Fuel apertures 84b in second fuel zone FZ2 are configured to provide fuel to flowpath 58 (FIG. 2) independent from fuel apertures 84a in first fuel zone FZ1. For example, first fuel zone FZ1 and second fuel zone FZ2 can provide fuel during differing operating conditions based on altitude and airspeed, among others. In some operating conditions, fuel is provided to first fuel zone FZ1 and second fuel zone FZ2 simultaneously. To facilitate independent fuel supply to second fuel zone FZ2 and first fuel zone FZ1, fuel apertures 84a can receive fuel separate from fuel apertures 84b. While spraybar 78 is described as including first fuel zone FZ1 and second fuel zone FZ2, it is understood that spraybar 78 can include as many or as few fuel zones as desired. For example, spraybar 78 can contain a single fuel zone and a single internal passage to supply fuel to all of the fuel apertures in the single fuel zone. In another example, spraybar 78 can include more than two fuel zones and can include an equal number of internal passages as fuel zones to supply fuel to the fuel apertures in the multiple fuel zones. It is understood, however, that spraybar 78 can include as many or as few fuel zones and associated internal passages as desired. Fuel apertures 84a and fuel apertures 84b are aligned along and/or parallel to longitudinal axis L-L of spraybar 78.

Fuel fitting 108a is attached to base 80 and extends into supply port 114. Fuel fitting 108b is attached to base 80 and extends into supply port 126. Fuel fittings 108a and 108b are configured to supply fuel to supply ports 114 and 126, respectively, and thus to first supply passage 104 and second supply passage 106. Fuel fittings 108a and 108b can be attached to base 80 in any desired manner, such as being removably attached, for example by threading onto base 80, or permanently attached, such as by welding to base 80.

First supply passage 104 extends from base 80 through spray arm 82a and spray arm 82b and is configured to supply fuel to fuel apertures 84a in first fuel zone FZ1. Supply port 114 is formed in base 80, and first branch 110 and second branch 112 extend from supply port 114. First branch 110 extends through spray arm 82a and is configured to provide fuel to fuel apertures 84a in first fuel zone FZ1 on spray arm 82a. Similarly, second branch 112 extends through spray arm 82b and is configured to provide fuel to fuel apertures 84a in first fuel zone FZ1 on spray arm 82b. First branch 110 and second branch 112 each receive fuel from supply port 114. With first branch 100 and second branch 112 receiving fuel from a common source, fuel apertures 84a on both spray arm 82a and spray arm 82b are provided with a balanced fuel flow, such that an equal fuel flow is provided to the working environment through both spray arm 82a and spray arm 82b.

As shown in FIG. 5B, first portion 116 of first branch 110 extends through second fuel zone FZ2 and is offset from first branch 122. In some examples, first portion 116 extends parallel to first branch 122. Second portion 118 of first branch 110 extends through first fuel zone FZ1 and is fluidly connected to fuel apertures 84a in first fuel zone FZ1. In some examples, second portion 118 is aligned with first branch 122 on longitudinal axis L-L such that both fuel apertures 84a and fuel apertures 84b are disposed on longitudinal axis L-L. Offset passage 120 extends between and connects first portion 116 and second portion 118 of first branch 110. Offset passage 120 extends obliquely to longitudinal axis L-L to provide fuel from first portion 116, which is offset from longitudinal axis L-L, to second portion 118, which is aligned on longitudinal axis L-L

Similar to first supply passage 104, second supply passage 106 extends from base 80 through spray arm 82a and spray arm 82b. Second supply passage 106 is configured to supply fuel to fuel apertures 84b in second fuel zone FZ2. Supply port 126 is formed in base 80, and first branch 122 and second branch 124 extend into spray arms 82a and 82b, respectively, from supply port 126. First branch 122 extends into spray arm 82a and is configured to provide fuel to fuel apertures 84b in second fuel zone FZ2 on spray arm 82a. Similarly, second branch 124 extends through spray arm 82b and is configured to provide fuel to fuel apertures 84b in second fuel zone FZ2 on spray arm 82b. First branch 122 and second branch 124 each receive fuel from supply port 126. As such, fuel apertures 84b on both spray arm 82a and spray arm 82b are provided with a balanced fuel flow, such that an equal fuel flow is provided to the working environment through both spray arm 82a and spray arm 82b.

Fuel apertures 84a and 84b, first supply passage 104, and second supply passage 106 can be integrally formed in spraybar 78. In some examples, spraybar 78 is formed utilizing an additive manufacturing process, such as direct metal laser sintering (DMLS). In some other examples, spraybar 78 can be formed through a conventional manufacturing process, such as casting. Where spraybar 78 is formed through the conventional manufacturing process, first supply passage 104 and second supply passage 106 can be formed via drilling into spraybar 78. For example, first portion 116 can be formed by drilling through base 80 and into spray arm 82a. Second portion 118 can be portion by drilling into an end of spray arm 82a opposite base 80. The offset passage 120 can be formed by drilling a passage into spray arm 82a to connect first portion 116 and second portion 118. Any openings through a surface of spraybar 78 created by the drilling process can be plug welded. Fuel apertures 84a and 84b can similarly be created via a mechanical process, such as electric discharge machining (EDM).

Spraybar 78 provides significant advantages. Fuel apertures 84, first supply passage 104, and second supply passage 106 are integrally formed in spraybar 78 such that spraybar 78 is a unitary component. Forming spraybar 78 as a unitary component provides a simplified arrangement that eliminates any additional components or tubing required to route fuel to fuel apertures 84 through spraybar 78. Spraybar 78 being a unitary component also facilitates manufacturing of spraybar 78 using an additive manufacturing process, as spraybar 78 does not include additional components requiring separate manufacture and assembly, thereby simplifying the manufacturing and assembly processes. Moreover, fuel apertures 84a on both spray arm 82a and spray arm 82b receive fuel from supply port 114, ensuring a balanced fuel flow in the first fuel zone FZ1 through both spray arm 82a and spray arm 82b. Fuel apertures 84b on both spray arm 82a and spray arm 82b receive fuel from supply port 126, ensuring a balanced fuel flow in the second fuel zone FZ2 through both spray arm 82a and spray arm 82b. Providing a balanced fuel flow increases efficiency and eliminates additional wear on components that can be experienced due imbalanced fuel flow.

FIG. 6A is a cross-sectional view taken along line A-A in FIG. 5B. FIG. 6B is a cross-sectional view taken along line B-B in FIG. 5B. FIGS. 6A and 6B will be discussed together. Spray arm 82a and spray arm 82b (collectively “spray arms 82”) are shown. Spray arm 82a includes first branch 110 of first supply passage 104 (best seen in FIGS. 5A-5C) and first branch 122 of second supply passage 106 (best seen in FIGS. 5A-5C). Spray arm 82b includes second branch 112 of first supply passage 104 and second branch 124 of second supply passage 106. Fuel apertures 84 each include window 130 and orifice 132. Window 130 includes base diameter D1 and outer diameter D2. Orifice 132 includes orifice diameter D3.

Fuel apertures 84 are configured to provide fuel to a working environment, such as flowpath 58 (shown in FIG. 2). Both first supply passage 104 and second supply passage 106 extend through spray arms 82 and are configured to provide fuel to fuel apertures 84. For each fuel aperture 84, window 130 extends into an outer surface of spray arm 82. Orifice 132 extends through a base of window 130 and fluidly connects window 130 and an internal passage, such as first supply passage 104 or second supply passage 106. Both window 130 and orifice 132 are integrally formed in spray arm 82 such that neither orifice 132 nor window 130 are movable relative to the other. As such, orifice 132 cannot become offset from window 130 and orifice 132 is thus not subject to eclipsing.

Window 130 is tapered such that outer diameter D2 is greater than base diameter D1. Tapering window 130 provides greater diffusion of fuel through window 130. Orifice diameter D3 is smaller than base diameter D1 of window 130. In some examples, orifice diameter D3 is about 5-10 times smaller than base diameter D1.

Fuel apertures 84 provide significant advantages. Fuel apertures 84 are integrally formed in spray arms 82 such that orifice 132 and window 130 are not relatively moveable. As such, orifice 132 cannot become displaced relative to window 130, and fuel aperture 84 is not subject to eclipsing, providing increased efficiency and reliability of spraybar 78. Integrally forming fuel apertures 84 also eliminates any additional components that were required to maintain alignment of orifice 132 and window 130, such as springs, clips, and other mechanical components. Eliminating the additional components simplifies fuel apertures 84 and prevents wear due to vibration or other relative movement of components, thereby providing an increased lifespan for spraybar 78.

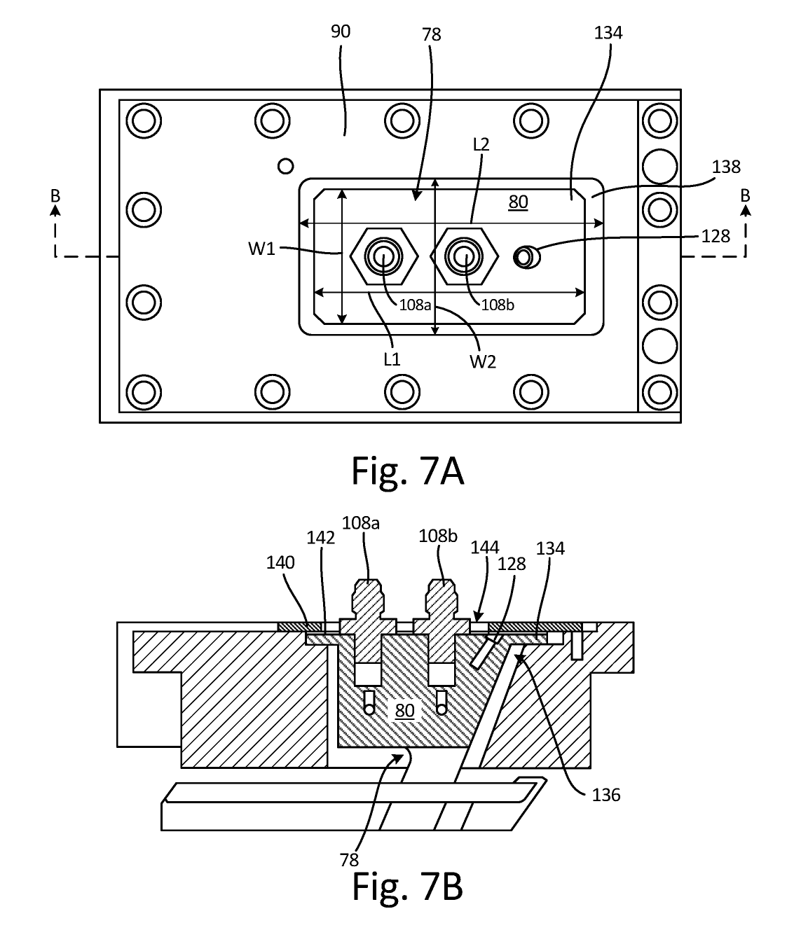

FIG. 7A is a top view of spraybar 78 on flange support 90. FIG. 7B is a cross-sectional view taken along line B-B in FIG. 7A. Base 80, spray arm 82b, first supply passage 104, and second supply passage 106 of spraybar 78 are shown. Base 80 includes tapped hole 128 and flange 134. Flange 134 has width W1 and length L1. Flange support 90 includes chamber 136, support surface 138, seal plate 140, and gasket 142. Support surface 138 has width W2 and length L2. Seal plate 140 includes opening 144.

Base 80 is disposed in chamber 136 of flange support 90. Tapped hole 128 extends into base 80 and is configured to receive an object to facilitate installation and removal of spraybar 78 from trailing edge box 64. In some examples, tapped hole 128 is a threaded hole configured to receive a threaded object, such as a bolt, which can be utilized to install or remove spraybar 78. Flange 134 extends from base 80 and rests on support surface 138. Gasket 142 is disposed on a top of flange 134, opposite support surface 138, and provides a spacer and wear protection between flange 134 and seal plate 140. Seal plate 140 is attached to flange support 90 and retains base 80 within chamber 136. Seal plate 140 includes opening 144 through which fuel fittings 108a and 108b can extend.

Support surface width W2 is greater than flange width W1, and support surface length L2 is greater than flange length L1. With support surface width W2 being greater than flange width W1, flange 134 is able to slide relative to support surface 138 in the width direction during operation. Similarly, with support surface length L2 being greater than flange length L1, flange 134 is able to slide relative to support surface 138 in the length direction during operation. As such, flange 134 is able to slide relative to support surface 138 during operation. Moreover, chamber 136 is dimensionally larger than base 80 such that base 80 is able to shift within chamber 136 during operation. With flange 134 slidable relative to support surface 138 and chamber 136 being dimensionally larger than base 80, relative thermal growth will not adversely affect spraybar 78. In some examples, spraybar 78 is not fixedly attached to any component; instead, spraybar 78 is retained by flange support 90 and seal plate 140. In other examples, base 80 of spraybar 78 can be attached to a radially distal end of trailing edge box 64.

Flange support 90 provides significant advantages. Flange support 90 supports spraybar 78 while allowing spraybar 78 to shift relative to flange support 90. Allowing spraybar 78 to shift relative to flange support 90 reduces wear and stress on various components.

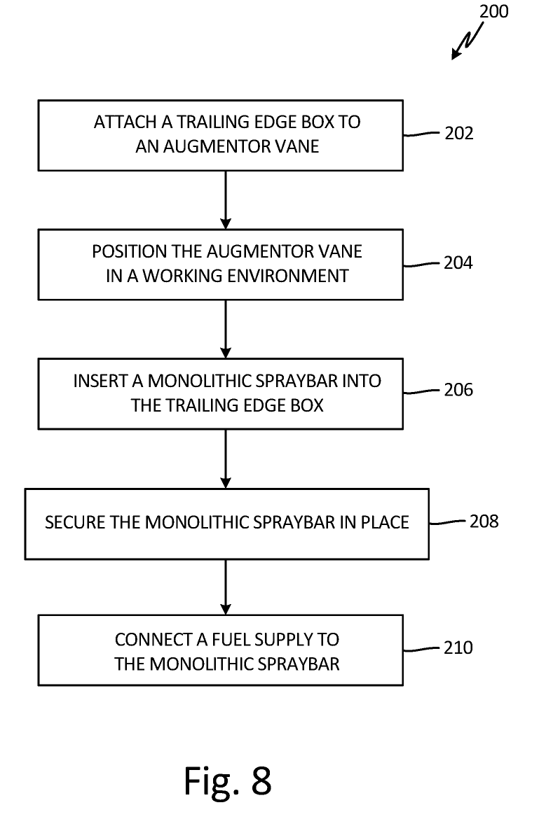

FIG. 8 is a flowchart of method 200 of assembling an augmentor vane. In step 202, a trailing edge box, such as trailing edge box 64, is attached to an augmentor vane, such as augmentor vane 54. The trailing edge box 64 can be secured to the augmentor vane in any desired manner, such as with fasteners extending through the trailing edge box and into the augmentor vane. In step 204, the augmentor vane can also be positioned in a working environment. In some examples, the augmentor vane can be secured within an augmentor stage of a gas turbine engine, such as gas turbine engine 10 (FIG. 1). For example, a turbine exhaust case, such as turbine exhaust case 48 (FIG. 1) can be secured between the turbine section and the exhaust case of the gas turbine engine. In some examples, the augmentor vane can be inserted into a test rig, such as a pressure vessel.

In step 206, a monolithic spraybar, such as spraybar 78 (best seen in FIGS. 5A-5C), is inserted into the trailing edge box. The monolithic spraybar can be slid onto the trailing edge box such that a spray arm, such as spray arms 82a and 82b (best seen in FIG. 5A), of the monolithic spraybar is disposed in a slot of the trailing edge box. In one example, the monolithic spraybar includes a first spray arm and a second spray arm, and the first spray arm and second spray arm are slid into slots, such as slots 70a and 70b (best seen in FIG. 3B) on the trailing edge box. In some examples, the spraybar 78 is inserted through an outer case, such as outer case 50, such that the spray arms extend radially inward from the outer case towards the inner case. In other examples, the spraybar is inserted through an inner case, such as inner case 52, such that the spray arms extend radially from the inner case towards the outer case. The spraybar can include a base, such as base 80 (best seen in FIG. 5C), that the spray arms extend from. With the spray arms disposed in the slots of the trailing edge box, the base can be supported by a support portion, such as flange support 90 (best seen in FIGS. 7A-7B), in the outer case or the inner case. The spraybar is inserted such that integral fuel apertures, such as fuel apertures 84, are directly exposed to the working environment. In one example, the fuel apertures 84 face out of a slot opening of the slot in the trailing edge box.

In step 208, the monolithic spraybar is secured in place. In some examples, the spraybar is secured such that a spray arm is movable relative to the slot that the spray arm is disposed in. In one example, the monolithic spraybar is secured directly to a radially outer or radially inner edge of the trailing edge box, such as via a fastener. In another example, a seal plate is secured to the support portion to retain the base within the support portion. A gasket, such as gasket 142 (FIG. 7B), can be disposed between the base of the monolithic spraybar and the seal plate. While the monolithic spraybar is secured in place, in some examples the spraybar is not fixed in place. As such, the spraybar can be secured such that the base cannot exit the support portion but is able to shift within the support portion. In some examples, the monolithic spraybar is secured such that the spray arms are movable relative to and within the slots in trailing edge box.

In step 210, the monolithic spraybar is connected to a fuel supply. Fuel fittings can be attached to supply fuel directly to the base and can extend from the base out of the support portion. Fuel supply hoses can be connected to the fuel fittings that are secured directly to the monolithic spraybar, thereby providing fuel to the monolithic spraybar.

### Discussion of Possible Embodiments

The following are non-exclusive descriptions of possible embodiments of the present invention.

A fuel spraybar includes a first spray arm extending from a base and including a first longitudinal axis and a second spray arm extending from the base and including a second longitudinal axis. The first spray arm includes at least one first internal passage extending through the first spray arm from the base and at least one fuel aperture extending into the first spray arm and fluidly connected to the at least one first passage. The second spray arm includes the least one first internal passage extending through the second spray arm from the base and at least one fuel aperture extending into the second spray arm and fluidly connected to the at least one first internal passage.

The fuel spraybar of the preceding paragraph can optionally include, additionally and/or alternatively, any one or more of the following features, configurations and/or additional components:

The at least one first internal passage includes a common supply port disposed in the base, a first branch extending from the first common supply port through the first spray arm, the first branch fluidly connected to the at least one fuel aperture of the first spray arm, and a second branch extending from the first common supply port through the second spray arm, the second branch fluidly connected to the at least one fuel aperture of the second spray arm.

A second internal passage extending from the base through the first spray arm and the second spray arm. The at least one fuel aperture of the first spray arm includes a first outer zone aperture and a first inner zone aperture, and the at least one fuel aperture of the second spray arm includes a second outer zone aperture and a second inner zone aperture. The second internal passage fluidly connected to the first outer zone aperture and to the second outer zone aperture.

The first branch is fluidly connected to the first inner zone fuel aperture, and the second branch is fluidly connected to the second inner zone fuel aperture.

A first aperture axis extending through the first inner zone aperture and the first outer zone aperture is disposed parallel to the first longitudinal axis, and a second aperture axis extending through the second inner zone aperture and the second outer zone aperture is disposed parallel to the second longitudinal axis.

The second internal passage includes a second common supply port disposed in the base, a first branch extending from the second common supply port through the first spray arm, the first branch fluidly connected to the first outer zone fuel aperture, and a second branch extending from the second common supply port through the second spray arm, the second branch fluidly connected to the at least one fuel aperture of the second spray arm.

The first common supply port is configured to receive a first fuel fitting, and the second common supply port is configured to receive a second fuel fitting.

The at least one fuel aperture of the first spray arm includes a window extending into the first spray arm, an orifice extending between and fluidly connecting the window and the first internal passage, and a window base diameter is greater than an orifice diameter.

The window base diameter is 5-10 times greater than the orifice diameter.

The window includes a base having the window base diameter, wherein the orifice extends into the window through the base, an outer opening, the outer opening having a window outer diameter, and a wall extending between the base and an outer surface of the first spray arm, wherein the wall is tapered such that the window outer diameter is greater than the window base diameter.

A fuel supply assembly includes a trailing edge box for an augmentor vane and a fuel spraybar. The trailing edge box includes a first sidewall extending between a forward end of the trailing edge box and a rear end of the trailing edge box, the first sidewall including a first slot open to a trailing edge box exterior, a second sidewall spaced from the first sidewall and extending between the forward end and the rear end, the second sidewall including a second slot open to the trailing edge box exterior, and a compartment disposed between the first sidewall and the second sidewall, the compartment configured to provide cooling air to the rear end of the trailing edge box. The fuel spraybar includes a first spray arm extending from a base, the first spray arm configured to supply fuel to a working environment through a plurality of first fuel apertures, the plurality of first fuel apertures integral with and extending into the first spray arm, and a second spray arm extending from the base, the second spray arm configured to supply fuel to the working environment through a plurality of second fuel apertures, the plurality of second fuel apertures integral with and extending into the second spray arm. The first spray arm is disposed in the first slot and the second spray arm is disposed in the second slot.

The fuel supply assembly of the preceding paragraph can optionally include, additionally and/or alternatively, any one or more of the following features, configurations and/or additional components:

A flame holder disposed between the first wall and the second wall proximate the rear end, the flame holder forming an aft wall of the compartment.

The base is disposed radially outward of the trailing edge box such that the first spray arm extends inward through the first slot and the second spray arm extends inward through the second slot.

At least one of the plurality of first fuel apertures includes a window extending into the first spray arm, the window comprising a base having a window base diameter, an outer opening extending through the first spray bar, the outer opening having a window outer diameter, and a wall extending between the base and an outer surface of the first spray arm, wherein the wall is tapered such that the window outer diameter is greater than the window base diameter, the fuel aperture further includes an orifice extending between and fluidly connecting the window and the first internal passage, the orifice having an orifice diameter, and wherein the orifice extends into the window through the base.

A first supply passage extending from the base and into the first spray arm and the second spray arm, the first supply passage configured to supply fuel to at least one of the plurality of first fuel apertures and at least one of the plurality of second fuel apertures.

The first supply passage includes a first common supply port disposed in the base, a first branch extending from the first common supply port through the first spray arm, the first branch fluidly connected to the first fuel aperture, and a second branch extending from the first common supply port through the second spray arm, the second branch fluidly connected to the second fuel aperture.

A second supply passage extending from the base through the first spray arm and the second spray arm. /the plurality of first fuel apertures includes a first outer zone fuel aperture and a first inner zone fuel aperture, and the plurality of second fuel apertures includes a second outer zone fuel aperture and a second inner zone fuel aperture and the second internal passage is fluidly connected to the first outer zone fuel aperture and the second outer zone fuel aperture.

The first branch is fluidly connected to the first inner zone fuel aperture, and the second branch is fluidly connected to the second inner zone fuel aperture.

The first spray arm is spaced from and extends parallel to the second spray arm.

A method of assembling an augmentor vane includes attaching a trailing edge box to an augmentor vane; and sliding a spray arm of the monolithic spraybar into a slot extending longitudinally along the trailing edge box, wherein the slot includes a retaining portion extending into a slot opening and configured to circumferentially retain the spray arm within the slot.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, is intended that the invention not be limited to the particular embodiment(s) disclosed, but that the invention will include all embodiments falling within the scope of the appended claims.

1. A fuel spraybar comprising:
a base;
a first spray arm extending from the base and including a first longitudinal axis, the first spray arm comprising:
at least one first internal passage extending through the first spray arm from the base; and
at least one fuel aperture extending into the first spray arm and fluidly connected to the at least one first supply passage;
a second spray arm extending from the base and including a second longitudinal axis, the second spray arm comprising:
the least one first internal passage extending through the second spray arm from the base; and
at least one fuel aperture extending into the second spray arm and fluidly connected to the at least one first supply passage.

2. The fuel spraybar of claim 1, wherein the at least one first internal passage comprises:
a common supply port disposed in the base;
a first branch extending from the first common supply port through the first spray arm, the first branch fluidly connected to the at least one fuel aperture of the first spray arm; and
a second branch extending from the first common supply port through the second spray arm, the second branch fluidly connected to the at least one fuel aperture of the second spray arm.

3. The fuel spraybar of claim 2, further comprising:
a second internal passage extending from the base through the first spray arm and the second spray arm;
wherein the at least one fuel aperture of the first spray arm includes a first outer zone aperture and a first inner zone aperture, and the at least one fuel aperture of the second spray arm includes a second outer zone aperture and a second inner zone aperture; and
wherein the second internal passage fluidly connected to the first outer zone aperture and to the second outer zone aperture.

4. The fuel spraybar of claim 3, wherein the first branch is fluidly connected to the first inner zone fuel aperture, and the second branch is fluidly connected to the second inner zone fuel aperture.

5. The fuel spraybar of claim 4, wherein:
the first outer zone aperture and the first inner zone aperture are aligned with the first longitudinal axis; and
the second outer zone aperture and the second inner zone aperture are aligned with the second longitudinal axis.

6. The fuel spraybar of claim 3, wherein the second internal passage comprises:
a second common supply port disposed in the base;
a first branch extending from the second common supply port through the first spray arm, the first branch fluidly connected to the first outer zone fuel aperture; and
a second branch extending from the second common supply port through the second spray arm, the second branch fluidly connected to the at least one fuel aperture of the second spray arm.

7. The fuel spraybar of claim 6, wherein the first common supply port is configured to receive a first fuel fitting, and the second common supply port is configured to receive a second fuel fitting.

8. The fuel spraybar of claim 1, wherein the at least one fuel aperture of the first spray arm comprises:
a window extending into the first spray arm; and
an orifice extending between and fluidly connecting the window and the first internal passage;
wherein a window base diameter is greater than an orifice diameter.

9. The fuel spraybar of claim 8, wherein the window base diameter is 5-10 times greater than the orifice diameter.

10. The fuel spraybar of claim 8, wherein the window comprises:
a window base having the window base diameter, wherein the orifice extends into the window through the window base;
an outer opening, the outer opening having a window outer diameter; and
a wall extending between the window base and an outer surface of the first spray arm, wherein the wall is tapered such that the window outer diameter is greater than the window base diameter.

11. A fuel supply assembly comprising:
a trailing edge box for an augmentor vane, the trailing edge box comprising:
a first sidewall extending between a forward end of the trailing edge box and a rear end of the trailing edge box, the first sidewall including a first slot open to a trailing edge box exterior;
a second sidewall spaced from the first sidewall and extending between the forward end and the rear end, the second sidewall including a second slot open to the trailing edge box exterior; and
a compartment disposed between the first sidewall and the second sidewall, the compartment configured to provide cooling air to the rear end of the trailing edge box; and
a fuel spraybar comprising:
a base;
a first spray arm extending from the base, the first spray arm configured to supply fuel to a working environment through a plurality of first fuel apertures, the plurality of first fuel apertures integral with and extending into the first spray arm; and
a second spray arm extending from the base, the second spray arm configured to supply fuel to the working environment through a plurality of second fuel apertures, the plurality of second fuel apertures integral with and extending into the second spray arm;
wherein the first spray arm is disposed in the first slot and the second spray arm is disposed in the second slot.

12. The fuel supply assembly of claim 11, further comprising:
a flame holder disposed between the first wall and the second wall proximate the rear end, the flame holder forming an aft wall of the compartment.

13. The fuel supply assembly of claim 11, wherein the base is disposed radially outward of the trailing edge box such that the first spray arm extends inward through the first slot and the second spray arm extends inward through the second slot.

14. The fuel supply assembly of claim 11, further comprising:
a first supply passage extending from the base and into the first spray arm and the second spray arm, the first supply passage configured to supply fuel to at least one of the plurality of first fuel apertures and at least one of the plurality of second fuel apertures.

15. The fuel supply assembly of claim 14, wherein the first supply passage comprises:
a first common supply port disposed in the base;
a first branch extending from the first common supply port through the first spray arm, the first branch fluidly connected to the first fuel aperture; and
a second branch extending from the first common supply port through the second spray arm, the second branch fluidly connected to the second fuel aperture.

16. The fuel supply assembly of claim 15, further comprising:
a second supply passage extending from the base through the first spray arm and the second spray arm; and
wherein the plurality of first fuel apertures includes a first outer zone fuel aperture and a first inner zone fuel aperture, and the plurality of second fuel apertures includes a second outer zone fuel aperture and a second inner zone fuel aperture; and
wherein the second internal passage is fluidly connected to the first outer zone fuel aperture and the second outer zone fuel aperture.

17. The fuel supply assembly of claim 16, wherein the first branch is fluidly connected to the first inner zone fuel aperture, and the second branch is fluidly connected to the second inner zone fuel aperture.

18. The fuel supply assembly of claim 11, wherein at least one of the plurality of first fuel apertures comprises:
a window extending into the first spray arm, the window comprising:
a window base having a window base diameter;
an outer opening extending through the first spray arm, the outer opening having a window outer diameter; and
a wall extending between the window base and an outer surface of the first spray arm, wherein the wall is tapered such that the window outer diameter is greater than the window base diameter; and
an orifice extending between and fluidly connecting the window and the first internal passage, the orifice having an orifice diameter;
wherein the orifice extends into the window through the window base.

19. The fuel supply assembly of claim 11, wherein the first spray arm is spaced from and extends parallel to the second spray arm.

20. A method of assembling an augmentor vane, the method comprising:
attaching a trailing edge box to an augmentor vane; and
sliding a spray arm of the monolithic spraybar into a slot extending longitudinally along the trailing edge box, wherein the slot includes a retaining portion extending into a slot opening and configured to circumferentially retain the spray arm within the slot.
